(19) United States
(12) Patent Application Publication
(10) Pub. No.: US 2019/0178433 A1
(43) Pub. Date: Jun. 13, 2019

(54) MAINTENANCE OF DRILLING RISERS

(71) Applicant: Oceaneering International, Inc., Houston, TX (US)

(72) Inventors: Patrick J Donovan, Portsmouth, RI (US); Michael William Killeen, Houston, TX (US); Daniel J. Scoville, The Woodlands, TX (US); Mark Alan Stevens, Houston, TX (US); Rajashekar Venkatachalam, Cypress, TX (US)

(73) Assignee: Oceaneering International, Inc., Houston, TX (US)

(21) Appl. No.: 16/213,691

(22) Filed: Dec. 7, 2018

Related U.S. Application Data
(60) Provisional application No. 62/596,806, filed on Dec. 9, 2017.

(51) Int. Cl. F16L 55/32; E21B 37/00; B62D 55/24; B62D 55/104

(52) U.S. Cl. CPC F16L 55/32; E21B 37/00; E21B 2023/008; B62D 55/104; B62D 55/24

(57) ABSTRACT

A tool system comprises a crawler, one or more tool interfaces, one or more tools operatively in communication with at least one the tool interface and adapted to perform a predetermined function in an interior of a predefined space, and a power interface. The tool system is deployed within the interior of the predefined space, e.g. a drilling riser, typically after operatively attaching a tool to a tool interface. Power is to the tool system which is moved to a position within the interior of where a predetermined function is to occur and the tool used to perform the predetermined function at the position within the interior of the predefined space where the predetermined function is to occur. In an embodiment, tool system comprises a first tool adapted to perform a first predefined function, e.g. a cleaning function, and second tool adapted to perform a second predefined function, e.g. an inspection function, where the two functions may be performed in a single pass of the tool system in the interior.

### RELATION TO OTHER APPLICATIONS

This application claims priority through U.S. Provisional Application 62/596,806 filed Dec. 9, 2017.

### BACKGROUND

Cleaning and inspection of drilling risers is performed every year (or) every 5 (or) 10 years depending on the requirements from the OEM. Currently two different tools are used, one for the purpose of cleaning and the other for inspection. Also, currently the methods that are used for inspection are based on spot measurements made using UT and MPI techniques.

Drilling risers also typically have buoyancy modules on the outside surface and hence external inspection typically is not feasible

### FIGURES

Various figures are included herein which illustrate aspects of embodiments of the disclosed inventions.

FIG. 1 is a first view in partial perspective of an exemplary tool system;

FIG. 2 is a second view in partial perspective of an exemplary tool system;

FIG. 3 is a view in partial perspective of an exemplary tool display deployed in a tubular;

FIG. 4 is a cross-sectional view in partial perspective of an exemplary tool display deployed in a tubular with propulsion system engaged; and

FIG. 5 is a flowchart of exemplary inspection strategies.

### DESCRIPTION OF EXEMPLARY EMBODIMENTS

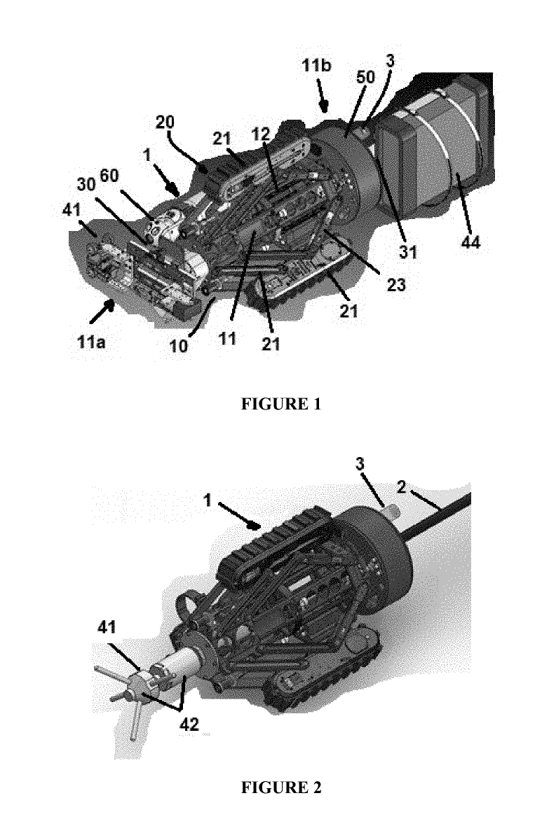

In a first embodiment, referring generally to FIG. 1, tool system 1 comprises crawler 10; propulsion system 20; tool interface 30,31 disposed at a predetermined portion of crawler 10; one or more tools 40 (generally referred to as “40” which is not shown in the figures but more specifically illustrated as tool 41-43) operatively in communication with one or more tool interfaces 30,31 and disposed at a predetermined portion of crawler 10, and one or more power interfaces 3.

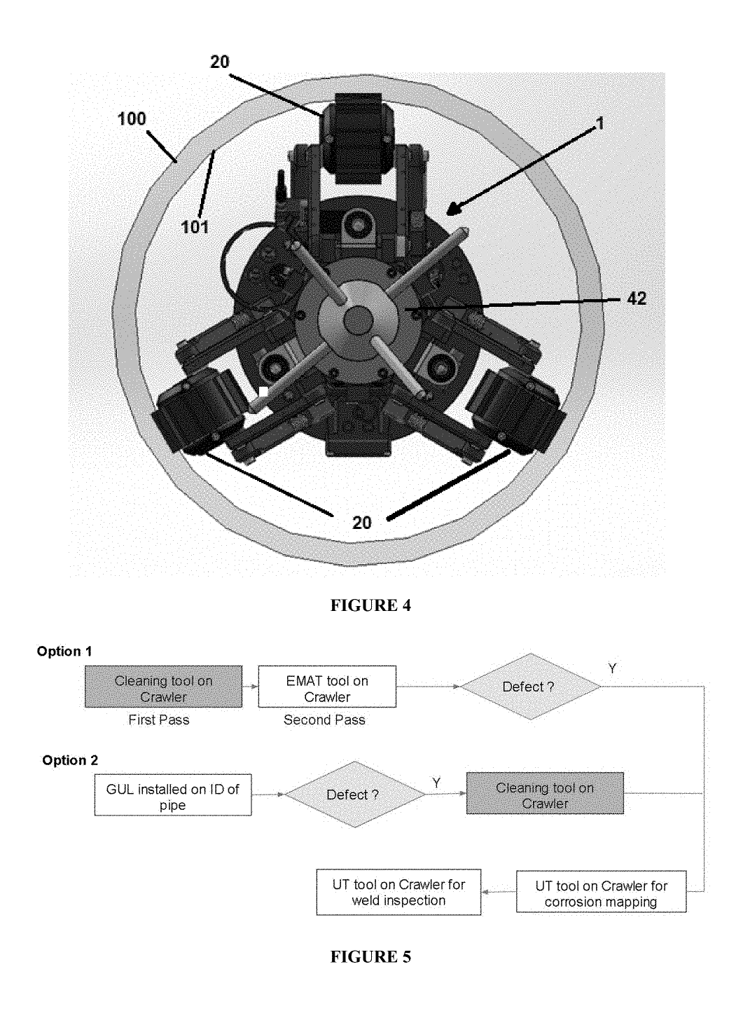

Crawler 10 typically comprises housing 11, which is sized to fit within interior 101 (FIG. 4) of a predefined space of tubular 100 (which may be a drilling riser), motor 12 disposed at least partially within housing 11, and propulsion system 20 which is operatively in communication with motor 12. The predetermined portion of crawler 10 typically comprises an outer portion of housing 11 and tools 40 are typically disposed at a predetermined portion of crawler 10 which may comprise a portion that is at least partially within the predetermined portion of crawler 10.

Propulsion system 20 is typically disposed at least partially about an outer portion of housing 11 and adapted to engage an inner surface of interior 101 (FIG. 4) of the predefined space such as of tubular 100 and propel crawler 10 along the inner surface.

In an embodiment, propulsion system 20 comprises a plurality of treads 21 operatively in communication with motor 12. Further, in embodiments propulsion system 20 comprises a plurality of arms 23, each arm 23 typically pivotally connected to housing 10, by way of example and not limitation in a scissor-jack arrangement, and one of the plurality of treads 21.

At least one power interface 2 is operatively in communication with motor 12 and tool 40 and typically comprises an electrical power interface, a hydraulic power interface, or the like, or a combination thereof.

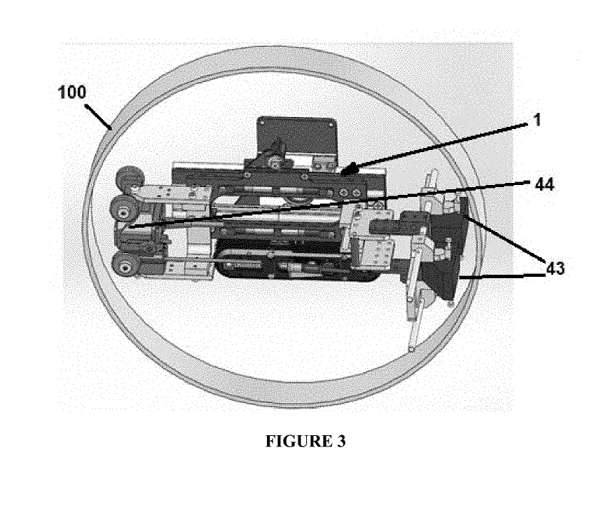

In embodiments, tools 40 comprise first tool 41, which is adapted to perform a first predefined function and which is disposed about first end 11a of housing 11, and second tool 43 (FIG. 3) which is adapted to perform a second predefined function and typically disposed about second end 11b of housing 11 opposite first end 11a of housing 11. By way of example and not limitation, first tool 41 may be a cleaning tool and further comprise rotary head water system 42 (FIG. 2) disposed at a predetermined end of cleaning tool 41. By way of further example and not limitation, second tool 43 may be an inspection tool comprising a phased array ultrasonic (UT) probe, a corrosion mapping UT scanner capable of aiding in a generation of a complete thickness map of a tubular such as a drilling riser, a weld inspection scanner, or the like, or a combination thereof. The corrosion mapping UT scanner may comprise a hydro-form scanner. The weld inspection scanner may comprise a phased array scanner. However, it is also contemplated that two or more tools may be disposed proximate the same end of housing 11, e.g. 11a.

In certain embodiments, tool system 1 further comprises sensor 44 which may be a guided ultrasonic sensor, an EMAT sensor, a weld inspection scanner, a phased array ultrasonic sensor, or the like, or a combination thereof. As used herein, a sensor may be a probe, e.g. a phased array ultrasonic probe.

In certain embodiments, tool system 1 further comprises one or more rotating arms 50 typically disposed at second end 11b of housing 11 and adapted to rotate 360° degrees about a predetermined rotation point. In certain of these embodiments, one or more sensors 44, which may be scanners as described above, may also be present and connected to at least one rotating arm 50.

In certain embodiments, tool system 1 further comprises a self-rotary swivel operatively connected to tool 40 and one or more rotating arms 50 are operatively connected to the self-rotary swivel.

Referring additionally to FIG. 2, in most embodiments, In certain embodiments, tool system 1 further comprises fluid conduit 2 disposed within an interior of housing 11 where fluid conduit 2 comprises a fluid interface adapted to provide fluid to one or more tools 40, by way of example and not limitation to provide cleaning fluid or hydraulic fluid. Fluid conduit 2 typically is disposed within a center of crawler 10 and connected to a port on tool 40 used for cleaning to provide fluid to tool 40 under pressure such as from one or more high pressure pumps.

One or more additional tools such as a camera or lights, illustrated at 60, may be present as well.

In the operation of exemplary methods, referring back to FIG. 1 and, generally, FIG. 5 for an example, in general a function may be performed using tool system 1, which is as described above, by operatively attaching tool 40, which is adapted to perform a predetermined function in interior 101 of the predefined space, to an appropriate tool interface 30,31 and deploying tool system 1 within interior 101 (FIG. 4) of the predefined space. Power is typically provided to tool system 1 such as via one or more power interfaces 3 and tool system 1 moved to a position within interior 101 of the predefined space where the predetermined function is to occur. This is typically accomplished using propulsion system 20 but may also be accomplished using any other appropriate placement means such as via a wireline or umbilical or the like. Once in position, tool system 1 uses tool 40 to perform the predetermined function. Further movement within interior 101 of the predefined space where the predetermined function is to occur is typically accomplished by engaging propulsion system 20 against interior 101 of the predefined space where the predetermined function is to occur and then using propulsion system 20 to effect further movement within the predefined space where the predetermined function is to occur.

In an embodiment, the predetermined function comprises cleaning interior 101 (FIG. 4) and tool 40 is adapted to accomplish such a cleaning of interior 101 such as by using a cleaning tool that comprises rotary head water system 42 (FIG. 2). In certain embodiments, the space to be cleaned is defined by an interior diameter of a drilling riser.

In other embodiments, the predetermined function comprises screening interior 101 (FIG. 4) using tool system 1 and tool 40 comprises one or more sensors 44 operatively attached to at least one tool interface 30,31. Tool system 1 is moved to a position within interior 101 where the predetermined function is to occur, as described above, and sensor 44 used to screen the space to be scanned. In this embodiment as well, a predetermined set of screening result data may be archived and used to aid in making predictions about and monitoring the over-all health of the drilling riser.

If sensor 44 comprises a guided ultrasonic sensor and the space to be scanned is defined by interior 101 (FIG. 4) of a drilling riser, the screening performed is typically useful to aid in determining wall loss.

In a further embodiment, the predetermined function comprises mapping corrosion from with interior 101 (FIG. 4) and tool 40 typically comprises a corrosion mapping ultrasonic testing scanner. As described above, tool system 1 is moved to a position within interior 101 where the predetermined function is to occur, which in this embodiment comprises moving tool system 1 to a position within interior 101 where corrosion mapping is to occur. Tool 40 is then used to effect creation of corrosion map of interior 101. In this embodiment, tool system 1 may further comprise one or more rotating arms 50 to which the corrosion mapping ultrasonic testing scanner is operatively connected. If the space to be scanned is defined by an interior of a drilling riser, the corrosion mapping ultrasonic testing scanner may be used to generate a complete thickness map of the drilling riser by using rotating arm 50 and the corrosion mapping ultrasonic testing scanner used to collect data along a predefined arc within an interior of the drilling riser. Rotating arm 50 is typically adapted to rotate an entire 360° and the predefined arc comprises all 360° of interior 101 of the drilling riser. In this embodiment as well, a predetermined set of corrosion mapping data may be archived and used to aid in making predictions about, and/or monitoring, the over-all health of the drilling riser.

In a further embodiment, the predetermined function comprises inspection of a weld from with interior 101 (FIG. 4) and tool 40 comprises a phased array ultrasonic probe. Tool system 1 is moved, as described above, to a position within interior 101 where performing a weld inspection is to occur and the phased array ultrasonic probe used to perform a weld inspection. Similar to the functions described above, tool system 1 may further comprise one or more rotating arms 50 to which the weld inspection scanner is operatively connected. If the space to be scanned is defined by an interior of a drilling riser, the weld inspection scanner may be used to generate weld inspection data by using rotating arm 50 and the weld inspection scanner to collect weld inspection data along a predefined arc within interior 101 of the drilling riser. Rotating arm 50 is typically adapted to rotate an entire 360° and the predefined arc comprises all 360° of interior 101. In this embodiment as well, a predetermined set of weld inspection data may be archived and used to aid in making predictions about, and/or monitoring, the over-all health of the drilling riser.

In any of these embodiments, tool interface 30,31 may comprise a plurality of tool interfaces 30,31, e.g. first tool interface 30 and second tool interface 31, and tool 40 may further comprise first tool 41 adapted to perform a first predefined function, e.g. a cleaning function, and second tool 43 adapted to perform a second predefined function as described above, e.g. an inspection function. In these embodiments, tool system 1 is moved to a position within interior 101 (FIG. 4), as described above, where the first function is to occur and first tool 41 used to perform the first function and then moved to a position within interior 101 where the second function is to occur and second tool 43 used perform the second function. In this embodiment, the first and second locations may be co-located. Further, the first function and the second function may be performed in one pass of tool system 1 within interior 101, by way of example and not limitation by incorporating cleaning tool 41 on a front of crawler 10 and inspection tool 43 on or behind an opposite rear end of crawler 10 to allow cleaning and inspection of a drilling riser to occur in one pass.

In embodiments, tool system 1 may be used to perform screening inspections, e.g. by using EMAT or GUL techniques for screening inspection, followed by a detailed inspection using ultrasonic technology techniques.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1) A tool system, comprising:
a) a crawler, comprising:
i) a housing sized to fit within an interior of a predefined space;
ii) a motor disposed at least partially within the housing; and
iii) a propulsion system operatively in communication with the motor, the propulsion system disposed at least partially about an outer portion of the housing and adapted to engage an inner surface of the interior of the predefined space and propel the crawler along the inner surface;
b) a tool interface disposed at a predetermined portion of the crawler;
c) a tool operatively in communication with the tool interface and disposed at a predetermined location of the crawler; and
d) a power interface operatively in communication with the motor and the tool.

2) The tool system of claim 1, wherein the propulsion system comprises a plurality of treads.

3) The tool system of claim 1, wherein the propulsion system comprises a plurality of arms, each arm pivotally connected to the housing, each arm comprising a tread operatively in communication with the motor.

4) The tool system of claim 1, wherein the power interface comprises an electrical power interface or a hydraulic power interface.

5) The tool system of claim 1, wherein the predetermined portion of the crawler comprises the outer portion of the housing.

6) The tool system of claim 5, wherein the predetermined portion of the crawler comprises a portion that is at least partially within a predetermined portion of the crawler.

7) The tool of claim 1, wherein the tool comprises:
a) a first tool adapted to perform a first predefined function, the first tool disposed about a first end of the housing; and
b) a second first tool adapted to perform a second predefined function, the second tool disposed about a second end of the housing opposite the first end of the housing.

8) A method of performing a function using a tool system comprising a crawler which comprises a housing sized to fit within an interior of a predefined space, a motor disposed at least partially within the housing, and a propulsion system operatively in communication with the motor where the propulsion system is disposed at least partially about an outer portion of the housing and adapted to engage an inner surface of the interior of the predefined space and propel the crawler along the inner surface; a tool interface disposed at a predetermined portion of the crawler; a tool operatively in communication with the tool interface and disposed at a predetermined location of the crawler; and a power interface operatively in communication with the motor and the tool; the method comprising:
a) operatively attaching the tool to the tool interface, the tool adapted to perform a predetermined function in the interior of the predefined space;
b) deploying the tool system within the interior of the predefined space;
c) providing power to the tool system;
d) moving the tool system to a position within the interior of the predefined space where the predetermined function is to occur; and
e) using the tool to perform the predetermined function at the position within the interior of the predefined space where the predetermined function is to occur.

9) method of performing a function using a tool system of claim 8, wherein the tool interface comprises first tool interface and a second tool interface and the tool comprises a first tool adapted to perform a first predefined function, the first tool disposed about a first end of the housing and operatively in communication with the first tool interface and a second tool adapted to perform a second predefined function, the second tool disposed about a second end of the housing opposite the first end of the housing and operatively in communication with the second tool interface, wherein:
a) for the first tool,
i) moving the tool system to a position within the interior of the predefined space where the predetermined function is to occur further comprises moving the tool system to a position within the space to be cleaned where the first function is to occur; and
ii) using the tool to perform the predetermined function further comprises using the first tool to perform the first function within the interior of the space where the first function is to occur; and
b) further second tool,
i) moving the tool system to a position within the interior of the predefined space where the predetermined function is to occur further comprises moving the tool system to a position within the space where the second function is to occur; and
ii) using the tool to perform the predetermined function further comprises using the second tool to perform the second function within the interior of the space where the second function is to occur.

10) The method of performing a function using a tool system of claim 9, wherein the first function comprises a cleaning function and the second function comprises an inspection function.

11) method of performing a function using a tool system of claim 10, wherein the first function and the second function are to be performed in one pass of the tool system within the interior.
